(19) United States
(12) Patent Application Publication
(10) Pub. No.: US 2024/0191744 A1
(43) Pub. Date: Jun. 13, 2024

(54) KIND OF BENDING BOLT TYPE ANTI-LOOSENING NUT

(71) Applicants: Dongguan Jingtong Machinery Technology Co., Ltd., Dongguan (CN); Xi'an Xiongfeng Energy Saving Technology Co., Ltd., Xi'an (CN)

(72) Inventors: Qing Liu, Xi'an (CN); Yu Liu, Dongguan (CN); Quanxi Liu, Dongguan (CN); Xuyang Liu, Dongguan (CN); Ting Gao, Dongguan (CN); Ming Liu, Dongguan (CN); Junfeng Liu, Dongguan (CN); Meng Fan, Dongguan (CN); Xiaohong Wang, Dongguan (CN); Xiaoying Wang, Dongguan (CN); Peng Wang, Dongguan (CN); Wei Wang, Dongguan (CN); Jie Fan, Dongguan (CN); Jianyi Liu, Dongguan (CN)

(21) Appl. No.: 18/525,722

(22) Filed: Nov. 30, 2023

(30) Foreign Application Priority Data
Dec. 12, 2022 (CN) 2022233247965

(51) Int. Cl. F16B 39/12

(52) U.S. Cl. CPC F16B 39/12

(57) ABSTRACT

The invention proposes a kind of bending bolt type anti-loosening nut, which relates to the technical field of mechanical fastening. It comprises an upper nut and a lower nut, the upper nut and the lower nut are stacked on the outside of the bolt and used to tightly connect the bolt to the connecting piece, the lower nut is arranged close to the connecting piece, the upper nut is arranged on the outer end surface of the lower nut; the adjacent end between the upper nut and lower nut is provided with an inclined surface, the inclined surface is inclined towards the interior of the upper nut, so that an inclined plane angle with deformation space between the upper nut and lower nut is formed; the invention achieves the effect of preventing nut loosening, is low in price, easy to manufacture, and suitable for small or miniature anti-loosening nuts.

### 1. TECHNICAL FIELD

The invention relates to the technical field of mechanical fastening, in particular to a kind of bending bolt type anti-loosening nut.

### 2. BACKGROUND ART

In the field of mechanical fastening, it is common to use fastening nuts to secure bolts and prevent bolts from loosening during the operation of mechanical equipment. However, in existing technology, due to the vibrations generated by most mechanical equipment at certain frequencies, ordinary fastening nuts are prone to loosening.

In order to improve the anti-loosening effect of nuts, the existing technology often adopts anti-loosening methods or special structured anti-loosening nuts to prevent nut loosening. A common method is to tighten two stacked nuts and then bend a portion of the exposed bolt outside the nut to prevent the nut from disengaging from the bolt due to vibrations. However, this practice makes it difficult to disassemble the bolt from the nut and cannot form standardized products. A hardlock nut produced in Japan is commonly used, which has a good anti-loosening effect, but there are several drawbacks during use: 1. The structure is complex, and it is expensive, it requires strict material requirements, making it difficult to achieve the desired effect with ordinary materials, in some cases, using it once can result in thread damage, making it challenging to popularize its use; 2. The structure includes a positive tapered hole and an eccentric cone, which makes it difficult to apply the product to smaller nuts below M8 size because it is small in size and difficult to process; 3. The outer hexagon of the nut with the same specification is larger than that of an ordinary nut, therefore, it cannot be installed in some spaces that have been designed to use ordinary nuts due to their large size; 4. The positive tapered hole and eccentric cone of this type of nut are both close to the thread, during the tightening process, first, the thread is first squeezed and deformed, and then the bolt is deformed to achieve the anti-loosening effect, however, this design requires the use of high-quality steel with particularly high yield strength to ensure that the threads can achieve the elastic deformation during use, if the material is average, the thread profile will undergo plastic deformation during use, causing damage to the nut and bolt.

### 3. SUMMARY OF THE INVENTION

The object of the invention is to provide a kind of bending bolt type anti-loosening nut, which can achieve the effect of preventing nut loosening, is low in price, easy to manufacture, and suitable for small anti-loosening nuts, has good use effects and is suitable for use in equipment subjected to severe vibrations, such as machines, vehicles, railway tracks with large vibrations, and other places where fastened nuts are prone to loosen, it can also be used to prevent loosening of miniature nuts in devices such as micro motors and glasses.

The embodiments of the invention are realized in this way:

The embodiments of the invention provide a kind of bending bolt type anti-loosening nut, comprising an upper nut and a lower nut, the upper nut and the lower nut are stacked on the outside of the bolt and used to tightly connect the bolt to the connecting piece, the lower nut is arranged close to the connecting piece, and the upper nut is arranged on the outer end surface of the lower nut;

The adjacent end between the upper nut and lower nut is provided with an inclined surface, the inclined surface is inclined towards the interior of the upper nut, so that an inclined plane angle with deformation space between the upper nut and lower nut is formed.

In some embodiments of the invention, a washer is arranged between the lower nut and the connecting piece, and the washer is sleeved on the bolt.

In some embodiments of the invention, the inclined plane angle ranges from 5° to 9°.

In some embodiments of the invention, the initial state of the upper nut and the lower nut is point contact, and the fastening state of the upper nut and the lower nut is surface contact.

In some embodiments of the invention, the bolt is made of material with a certain amount of elastic deformation, the deformation inclination angle of the bolt is consistent with the inclined plane angle.

Compared with the prior art, the embodiments of the invention at least have the following advantages or advantageous effects:

The embodiments of the invention provide a kind of bending bolt type anti-loosening nut, comprising an upper nut and a lower nut, the upper nut and the lower nut are stacked on the outside of the bolt and used to tightly connect the bolt to the connecting piece, the lower nut is arranged close to the connecting piece, and the upper nut is arranged on the outer end surface of the lower nut; the adjacent end between the upper nut and lower nut is provided with an inclined surface, the inclined surface is inclined towards the interior of the upper nut, so that an inclined plane angle with deformation space between the upper nut and lower nut is formed; by setting the inclined surface on the upper nut to form an inclined plane angle with the lower nut, when the two nuts are locked, the contact point in the initial state is used as the fulcrum, so that the bolt is forced to undergo bending elastic deformation, the point contact between the upper nut and lower nut changes to surface contact, thereby locking the bolt, when disassembly is required, loosening the upper nut until it returns to its original state and then disassemble is finished; the invention can achieve the effect of preventing nut loosening, is low in price, easy to manufacture, and suitable for small anti-loosening nuts, has good use effects and is suitable for use in equipment subjected to severe vibrations, such as machines, vehicles, railway tracks with large vibrations, and other places where fastened nuts are prone to loosen, it can also be used to prevent loosening of miniature nuts in devices such as micro motors and glasses.

### 4. BRIEF DESCRIPTION OF ACCOMPANY DRAWINGS

In order to explain the technical schemes of the embodiments of the invention more clearly, the accompanying drawings required in the embodiments will be briefly introduced below. It should be understood that the following accompanying drawings only show some embodiments of the invention, therefore, it should not be regarded as a limitation on the scope. For those of ordinary skill in the art, other relevant accompanying drawings can also be obtained based on these accompanying drawings without exerting creative efforts.

FIG. 1 is a schematic diagram of a kind of bending bolt type anti-loosening nut in the embodiment of the invention;

FIG. 2 is a top view of a kind of bending bolt type anti-loosening nut in the embodiment of the invention;

FIG. 3 is a schematic diagram of a kind of bending bolt type anti-loosening nut when tightening in the embodiment of the invention.

As shown in the figures: 1 bolt, 2 washer, 3 connecting piece, 4 upper nut, 5 lower nut, 6 inclined surface, 7 inclined plane angle.

### 5. SPECIFIC EMBODIMENT OF THE INVENTION

### Embodiment

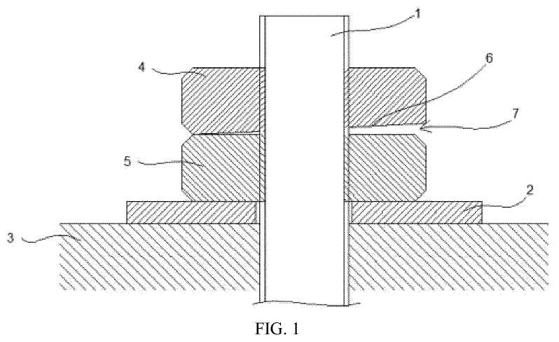

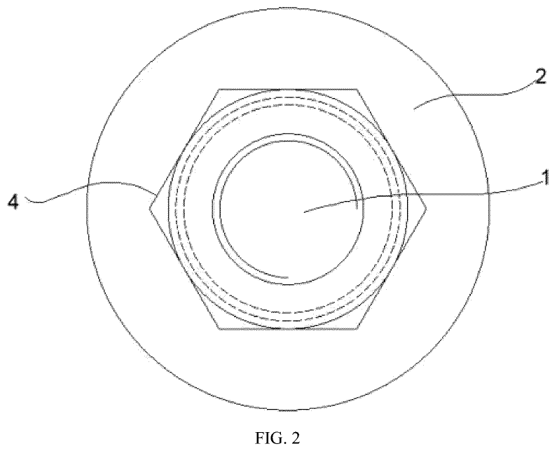

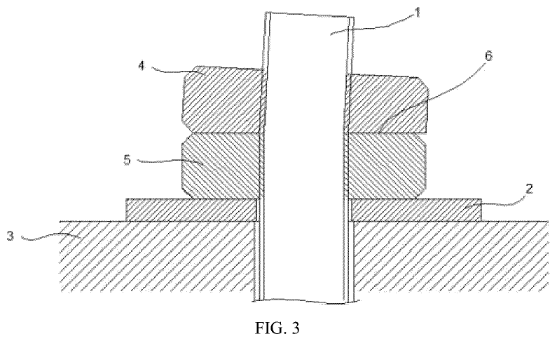

Please refer to FIG. 1 to FIG. 3, FIG. 1 is a schematic diagram of a kind of bending bolt type anti-loosening nut in the embodiment of the invention; FIG. 2 is a top view of a kind of bending bolt type anti-loosening nut in the embodiment of the invention; FIG. 3 is a schematic diagram of a kind of bending bolt type anti-loosening nut when tightening in the embodiment of the invention.

The embodiment of the invention is implemented as follow:

The embodiment of the invention provides a kind of bending bolt type anti-loosening nut, comprising an upper nut 4 and a lower nut 5, the upper nut 4 and the lower nut 5 are stacked on the outside of the bolt 1 and used to tightly connect the bolt 1 to the connecting piece 3, the lower nut 5 is arranged close to the connecting piece 3, and the upper nut 4 is arranged on the outer end surface of the lower nut 5; the adjacent end between the upper nut 4 and lower nut 5 is provided with an inclined surface 6, the inclined surface 6 is inclined towards the interior of the upper nut 4, so that an inclined plane angle 7 with deformation space between the upper nut 4 and lower nut 5 is formed; by setting the inclined surface 6 on the upper nut 4 to form an inclined plane angle 7 with the lower nut 5, when the two nuts are locked, the contact point in the initial state is used as the fulcrum, so that the bolt 1 is forced to undergo bending elastic deformation, the point contact between the upper nut 4 and lower nut 5 changes to surface contact, thereby locking the bolt 1, when disassembly is required, loosening the upper nut 4 until it returns to its original state and then disassemble is finished; the invention can achieve the effect of preventing nut loosening, is low in price, easy to manufacture, and suitable for small anti-loosening nuts, has good use effects and is suitable for use in equipment subjected to severe vibrations, such as machines, vehicles, railway tracks with large vibrations, and other places where fastened nuts are prone to loosen, it can also be used to prevent loosening of miniature nuts in devices such as micro motors and glasses.

A kind of bending bolt type anti-loosening nut of the exemplary embodiment will be further described below.

In some embodiments of the invention, the upper nut 4 and the lower nut 5 are stacked on the outside of the bolt 1 and used to tightly connect the bolt 1 to the connecting piece 3, the lower nut 5 is arranged close to the connecting piece 3, and the upper nut 4 is arranged on the outer end surface of the lower nut 5; by using two nuts to tighten and secure the bolt 1, the lower nut 5 serves as the fastening nut, while the upper nut 4 functions as the locking nut, they work together to increase the tightening force and prevent loosening, a washer 2 is arranged between the lower nut 5 and the connecting piece 3, and the washer 2 is sleeved on the bolt 1, the washer 2 can be an ordinary washer 2 to increase the locking force between the nuts and the connecting piece 3; the adjacent end between the upper nut 4 and lower nut 5 is provided with an inclined surface 6, the inclined surface 6 is inclined towards the interior of the upper nut 4, that is, the inclined surface 6 is inclined upward relative to one side of the lower nut 5, so that an inclined plane angle 7 with deformation space between the upper nut 4 and lower nut 5 is formed.

In a specific embodiment, after the lower nut 5 is tightened on the connecting piece 3 and the washer 2, screwing the upper nut 4 into the bolt 1, during the tightening process, due to the existence of the inclined plane angle 7, the upper nut 4 and the lower nut 5 are all unilaterally stressed, as the upper nut 4 is tightened, the inclined plane angle 7 gradually becomes smaller, at this time, the upper nut 4 will drive the bolt 1 to undergo elastic deformation toward the side of the inclined plane angle 7 until the upper nut 4 and the lower nut 5 fit each other, thereby locking the bolt 1 and the nuts.

As an example, the inclined plane angle ranges from 5° to 9°. Different angles can be selected according to different materials of the bolt 1, and larger angles can be selected for materials with better strength and elasticity.

In a specific embodiment, the adaptation angle can be designed according to changes in the thread profile, helix angle, number of thread heads, etc. of the bolt 1, the ordinary thread adopts an inclination angle of 7° or 9°, and the fine thread adopts an inclination angle of 5° or 6°.

As an example, the bolt 1 is made of material with a certain amount of elastic deformation, the deformation inclination angle of the bolt 1 is consistent with the inclined plane angle 7. The material of the ordinary bolt 1 or nuts has a certain amount of elastic deformation, compared with hardlock nuts, there is no need to use special high-quality steel, which can save manufacturing costs.

In practical use, placing the bolt 1 in the through-hole of connecting piece 3, then sleeving the washer 2 on the bolt 1, tightening the lower nut 5 and the upper nut 4 onto the bolt 1 through thread connection in sequence, rotating the lower nut 5 until it is in close contact with the washer 2, and then rotating the contact position between the upper nut 4 and the lower nut 5, when the upper nut 4 and the lower nut 5 are in contact, an inclined plane angle 7 is formed between the inclined surface 6 set on the upper nut 4 and the lower nut 5, the setting of the inclined surface 6 causes the initial state between the upper nut 4 and the lower nut 5 to be point contact, and the contact point is the support point, the contact position of the upper nut 4 and the lower nut 5 is located at a relatively lower position of the inclined surface 6 of the upper nut 4, when continuing to tighten the upper nut 4, and after the lower nut 5 is tightened, at this time, continuing to tighten the upper nut 4, one side of the support point of the inclined surface 6 of the upper nut 4 has no support, when the upper nut 4 is tightened downward, it moves downward along the helix angle of the bolt 1, when continuing to tighten the upper nut 4 downward, it is equivalent to the upper nut 4 using the contact point between the inclined surface 6 and the lower nut 5 as the fulcrum to pull the bolt 1 toward the open end of the inclined plane angle 7 and squeeze it, since the applied force generated when the upper nut 4 is tightened downwards is very large, it will force the bolt 1 to deform, so that the inclined surface 6 of the upper nut 4 and the plane of the lower nut 5 fit together, and the inclined plane angle 7 disappears, the bolt 1 bends and deforms, causing the bolt 1 to deviate from its original central axis, the lower nut 5 will also be affected by the bending deformation of the bolt 1, causing both the upper nut 4 and the lower nut 5 to be in an extremely unbalanced state, which has a good anti-loosening effect; after the force is stopped, the inclined plane angle 7 will decrease due to elastic deformation, and the inclined plane where the support point is located will produce a large friction force on the mating surface due to the pressure and the small angle of the helix angle of the upper nut 4, as a result, it is difficult for it to loosen during vibrations without external force, moreover, due to factors such as the bending deformation of the bolt 1 and the tilt deviation of the upper nut 4, the pitch between the upper nut and lower nut changes by a certain amount after locking because of the bending deformation of the bolt, making it difficult for the lower nut to move along the original spiral line during severe vibrations, so it will not loosen, this can effectively prevent loosening and provide good anti-vibration effect. When the upper nut 4 is tightened, without using tools to tighten hard, it is difficult for it to loosen even under significant external vibrations, even after prolonged periods. In the prior art, when both the upper nut 4 and the lower nut 5 are flat, the upper nut 4, which functions as a locking nut, will lose its locking effect as long as it moves within a small arc range; but for this kind of nut with inclined surface, in order to loosen it, the method is as follow: after the bending deformation of the bolt 1, loosening the upper nut 4 to the position before the bolt 1 bends and deforms, at this time, it needs to overcome the resistance caused by the elastic deformation of the bolt 1 when the nut is unscrewed, additionally, the upper nut 4 must be rotated in reverse for one or more turns before the upper nut 4 can be loosened. Therefore, it is difficult to loosen it by simply relying on external vibrations.

In summary, the advantageous effects are as follows:

1. Aimed at the existing anti-loosening nut, especially compared with the aforementioned Japanese-produced hardlock nut, the invention is simple in manufacturing process and provides a nut with good anti-loosening effects that does not require high material requirements, even with the use of ordinary materials, the elastic deformation of the bolt 1 is still within the yield strength range of the material, the greater the range of deformation of the part, the better the anti-loosening effect in resisting vibrations;

2. It is convenient for installation and disassembly, within the limited range of inclined angles, it allows for a certain degree of elastic deformation of the bolt 1 to prevent nut loosening, and it also ensures that the deformation of the bolt 1 is not too large to cause plastic deformation, which will affect future disassembly, moreover, it avoids the problem in the prior art that bending the bolt 1 causes irrecoverable plastic deformation and makes it difficult to disassemble, when disassembling the invention, simply unscrewing the upper nut 4 until it returns to its original state, and the bolt 1 can be disassembled without damaging either the bolt 1 or nuts, this allows for multiple reuses, resulting in cost savings;

3. It can be applied to nuts and bolts of different sizes and specifications, by conducting tests with various high-strength and regular nuts and bolts 1 of different specifications, excellent results have been achieved, this design is capable of withstanding severe vibrations without causing any loosening of the nuts;

4. The structure is simple and can be used for anti-loosening of miniature nuts that cannot be manufactured due to the complexity of their structure, such as those used for fastening in equipment such as glasses and micro motors; it is easy to manufacture and facilitate large-scale processing of the inclined surfaces on the nuts with the assistance of fixtures.

5. The anti-loosening effect is good, the scope of application is wide, and the practicality is strong, it is suitable for use in equipment subjected to severe vibrations, such as machines, vehicles, railway tracks with large vibrations, and other places where fastened nuts are prone to loosen.

The above are only preferred embodiments of the invention and are not intended to limit the invention. For those skilled in the art, the invention may have various modifications and changes. Any modifications, equivalent substitutions, improvements, etc. made within the spirit and principles of the invention shall be included in the protection scope of the invention.

1. A kind of bending bolt type anti-loosening nut comprises an upper nut and a lower nut, the upper nut and the lower nut are stacked on the outside of the bolt and used to tightly connect the bolt to the connecting piece, the lower nut is arranged close to the connecting piece, and the upper nut is arranged on the outer end surface of the lower nut;
the adjacent end between the upper nut and lower nut is provided with an inclined surface, the inclined surface is inclined towards the interior of the upper nut, so that an inclined plane angle with deformation space between the upper nut and lower nut is formed.

2. A kind of bending bolt type anti-loosening nut of claim 1, a washer is arranged between the lower nut and the connecting piece, and the washer is sleeved on the bolt.

3. A kind of bending bolt type anti-loosening nut of claim 1, the inclined plane angle ranges from 5° to 9°.

4. A kind of bending bolt type anti-loosening nut of claim 1, the initial state of the upper nut and the lower nut is point contact, and the fastening state of the upper nut and the lower nut is surface contact.

5. A kind of bending bolt type anti-loosening nut of claim 1, the deformation inclination angle of the bolt is consistent with the inclined plane angle.
